(19) United States
(12) Patent Application Publication
(10) Pub. No.: US 2021/0254660 A1
(43) Pub. Date: Aug. 19, 2021

(54) SLIDING BEARING

(71) Applicant: TAIHO KOGYO Co., Ltd., Toyota-shi, Aichi (JP)

(72) Inventors: Shintaro KATO, Toyota-shi, Aichi (JP); Kohei FUKAMI, Toyota-shi, Aichi (JP)

(21) Appl. No.: 17/274,648

(22) PCT Filed: May 31, 2019
(86) PCT No.: PCT/JP2019/021808

§ 371 Date: Mar. 9, 2021

(30) Foreign Application Priority Data
Sep. 14, 2018 (JP) 2018-172692

(51) Int. Cl. F16C 17/02; F16C 33/12

(52) U.S. Cl. CPC F16C 17/02; F16C 33/12

(57) ABSTRACT

Provided is a sliding bearing that can improve contact with a holder on a bearing rear surface and improve material yield. This sliding bearing comprises a pair of upper and lower half split members which are formed by bisecting a cylinder in a direction parallel to the axial direction thereof, the sliding bearing having hardened sections on the end faces of the upper half split member in the cylinder axial direction and hardened sections on the end faces of the lower half split member in the cylinder axial direction. The hardened sections are laser modified sections in which the properties of the material have been changed by the thermal influence of a laser.

### TECHNICAL FIELD

The present invention relates to a technique of a sliding bearing.

### BACKGROUND ART

Conventionally, there is known a sliding bearing which is a bearing for pivotally supporting a crankshaft of an engine, and which has a half split structure formed by joining two members obtained by bisecting a cylindrical shape. Further, in the above sliding bearing, a configuration is known in which an oil hole penetrating from an outer circumferential face to an inner circumferential face of the cylindrical shape is formed. As the sliding bearing provided with the oil hole, for example, there is one disclosed in Patent Literature 1.

### CITATIONS LIST

### Patent Literature

Patent Literature 1: JP-A 2016-191420 Gazette

### SUMMARY OF INVENTION

### Technical Problems

Conventionally, a blank material used to manufacture a sliding bearing is cut into a predetermined shape by press-cutting using a die and a punch, and the blank material is press-molded into a substantially semicircular half split member. The press-cut blank material has a work-hardened layer formed from a cut surface over a predetermined range. Because such a work-hardened layer causes a reduction in a contact area of the sliding bearing with respect to the holder, the work-hardened layer is entirely removed by cutting. In the conventional sliding bearing, an amount of work-hardened layer removed is large, and therefore, it is required to improve a material yield in the manufacturing of the sliding bearing.

Therefore, the present invention has been made in view of the above problem, and provides a sliding bearing in which contact of a bearing rear surface with respect to a holder is improved and the material yield is improved.

### Solution to Problems

The problem to be solved by the present invention is as described above. Next, means for solving the problem is described.

That is, a sliding bearing according to the present invention is a sliding bearing including a pair of half split members formed by bisecting a cylinder in a direction parallel to an axial direction, in which the half split members have hardened sections on end faces in a cylinder axial direction of the half split members.

Further, the sliding bearing according to the present invention is a sliding bearing including a cylindrical member formed integrally, in which the cylindrical member has hardened sections on end faces in a cylinder axial direction of the cylindrical member.

Further, in the sliding bearing according to the present invention, each of the hardened sections is a laser modified section.

Further, the sliding bearing according to the present invention has no inflection point in a shape along a line parallel to a cylinder axis of an outer circumferential face of each of the half split members.

### Advantageous Effects of Invention

The present invention has the following effects.

The sliding bearing according to the present invention can achieve both improvement in the contact of the bearing rear surface with respect to the holder and improvement in the material yield.

### BRIEF DESCRIPTION OF DRAWINGS

FIG. 1 is a front view showing a supported state of a crankshaft by a sliding bearing according to an embodiment of the present invention.

FIG. 2(A) is a plan view showing an upper half split member constituting the sliding bearing, and FIG. 2(B) is a bottom view showing the same.

FIG. 3(A) is a plan view showing a lower half split member constituting the sliding bearing, and FIG. 3(B) is a bottom view showing the same.

FIG. 4(A) is a schematic view of an end face cut along IV-IV line in FIG. 2(A) of the upper half split member, and FIG. 4(B) is a schematic view of an end face of an upper half split member in a conventional example.

FIG. 5 is a schematic perspective view for describing a method of cutting a blank material.

### DESCRIPTION OF EMBODIMENT

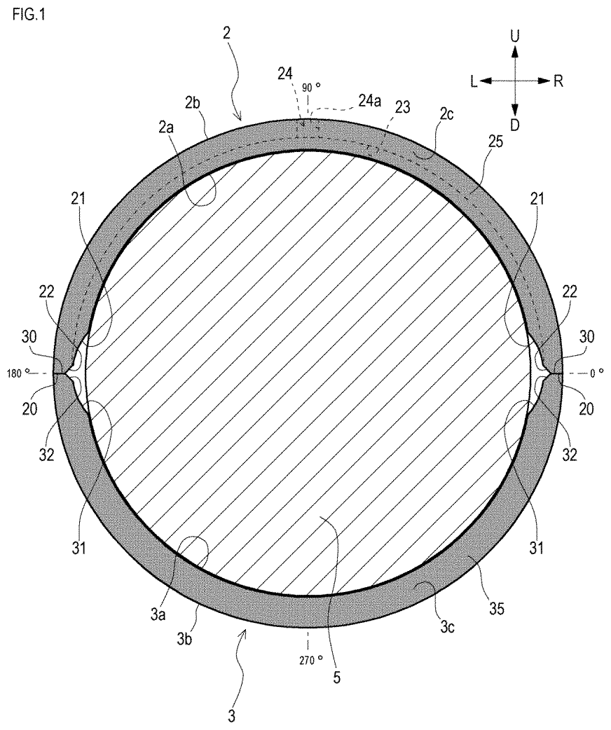

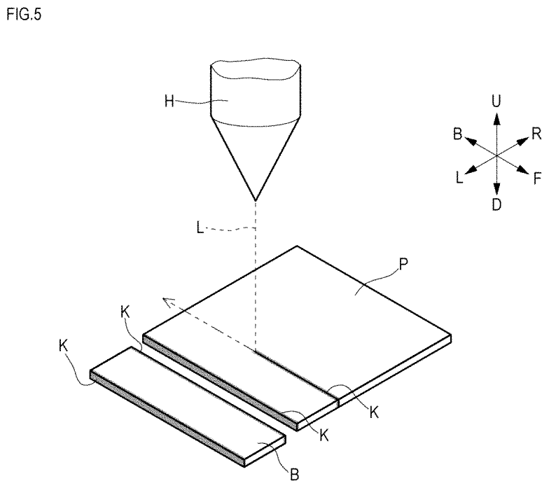

Next, an embodiment of the invention is described. In the following, the directions indicated by an arrow U, an arrow D, an arrow L, and an arrow R shown in FIG. 1 are defined as upward, downward, leftward, and rightward, respectively, and the same applies to the other figures. Further, the near side of a paper surface in FIG. 1 is defined as a front side and the far side of the paper surface is defined as the back side, and the same applies to the other figures. An arrow F indicates frontward and an arrow B indicates backward (see FIG. 5). Regarding a bearing angle ω around the cylinder axis of a sliding bearing 1, the right end position in FIG. 1 is defined as 0 degrees and the counterclockwise direction in FIG. 1 is defined as the positive direction. That is, the bearing angle to at the upper end position in FIG. 1 is defined as 90 degrees, the bearing angle to at the left end position as 180 degrees, and the bearing angle to at the lower end position as 270 degrees. The rotation direction of a crankshaft 5 is clockwise in FIG. 1.

First, the overall structure of the sliding bearing is described.

The sliding bearing 1 shown in FIG. 1 is an embodiment of the sliding bearing according to the present invention. The sliding bearing 1 is a metal bearing having a cylindrical shape, and is applied to a sliding bearing structure of the crankshaft 5 of an engine.

The sliding bearing 1 is constituted of an upper half split member 2 and a lower half split member 3. Each of the half split members 2 and 3 has a shape formed by bisecting a cylinder on a plane that passes through the cylinder axis of the cylinder, and has a semicircular shape when viewed in the cylinder axial direction. A direction along a circumference of the sliding bearing 1 as viewed in the cylinder axial direction is defined as the circumferential direction, and a direction orthogonal to the circumferential direction is defined as the radial direction.

The sliding bearing 1 is constituted by arranging the upper half split member 2 on the lower half split member 3 such that mating surfaces of the half split members 2 and 3 are located on a horizontal plane.

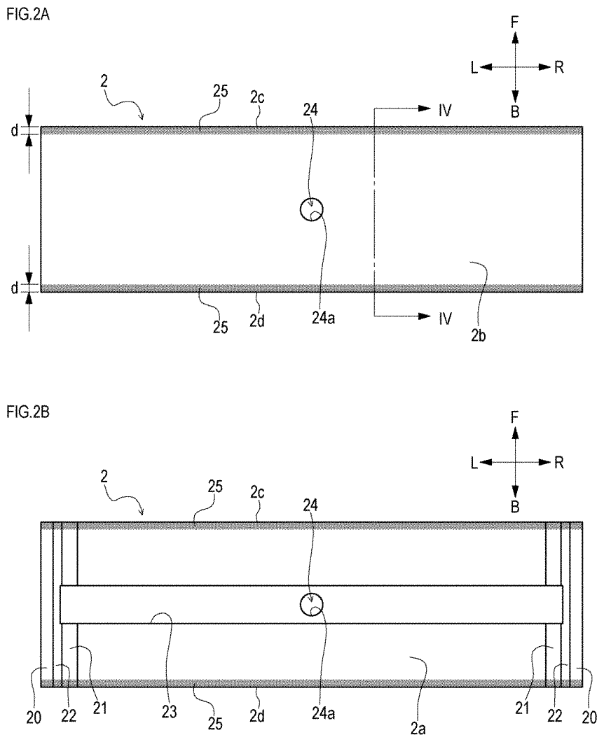

FIG. 2 is an embodiment of the upper half split member constituting the sliding bearing according to the present invention, and as shown in FIGS. 2(A) and (B), includes an inner circumferential face 2a, an outer circumferential face 2b, a front end face 2c, and a back end face 2d. Further, the upper half split member 2 includes mating surfaces 20, crush relieves 21, chamfered sections 22, an oil groove 23, an oil hole 24, and hardened sections 25.

The mating surfaces 20 are flat portions in contact with mating surfaces (mating surfaces 30 described later) of the lower half split member 3, and are formed as a pair of left and right downward-facing surfaces at both left and right ends of the upper half split member 2. The crush relieves 21 are portions formed by cutting out left and right edges of the inner circumferential face 2a of the upper half split member 2, and are formed of a left and right pair. The chamfered sections 22 are flat portions each of which connects an end of the mating surface 20 on the side of the inner circumferential face 2a with a lower end of the crush relief 21, and are formed of a left and right pair.

The oil groove 23 is a portion in which a groove section having a substantially rectangular cross section is formed along the circumferential direction at the center in the front-back direction of the inner circumferential face 2a of the upper half split member 2.

The oil hole 24 is a through hole formed at a position where the bearing angle to of the upper half split member 2 is 90 degrees, and communicates with the oil groove 23. In the present embodiment, the case is exemplified in which the oil hole 24 is formed at a position where the bearing angle to of the upper half split member 2 is 90 degrees, however, a position of forming the oil hole 24 is not limited to this.

The hardened sections 25 are portions each of which is formed in a range d from each of the end faces 2c and 2d of the upper half split member 2, and are hardened as compared with other portions. The hardened sections 25 are portions (laser modified sections K described later) formed when a steel plate (a blank material B described later) to be a material of the upper half split member 2 is cut by laser cutting using a laser machine and the vicinity of the cut surface is changed in properties by thermal influence of a laser. The range d of each of the hardened sections 25 is 350 μm or less.

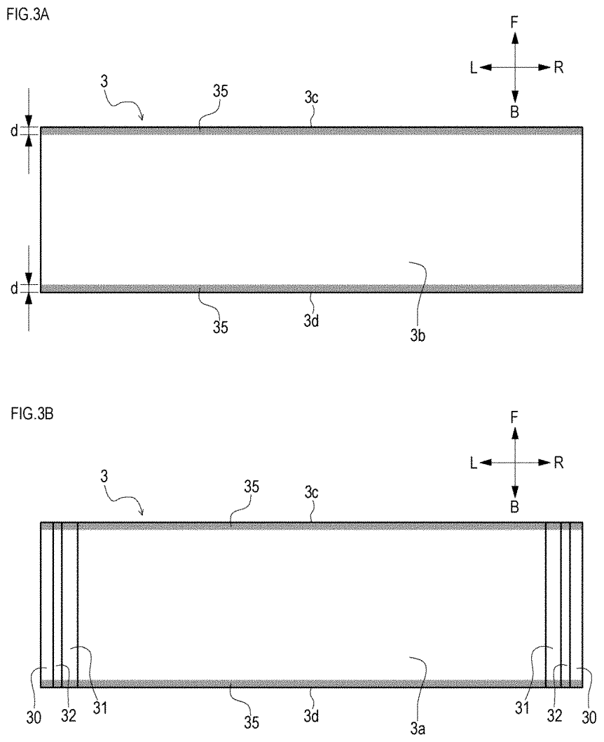

As shown in FIGS. 3(A) and 3(B), the lower half split member 3 includes an inner circumferential face 3a, an outer circumferential face 3b, a front end face 3c, and a back end face 3d. The lower half split member 3 also includes mating surfaces 30, crush relieves 31, chamfered sections 32, and hardened sections 35.

The mating surfaces 30 are flat portions in contact with the mating surfaces 20 of the upper half split member 2, and are formed as a pair of left and right upward-facing surfaces at both left and right ends of the lower half split member 3. The crush relieves 31 are portions formed by cutting out left and right edges of the inner circumferential face 3a of the lower half split member 3, and are formed of a left and right pair. The chamfered sections 32 are flat portions each of which connects an end of the mating surface 30 on the side of the inner circumferential face 3a with a lower end of the crush relief 31, and are formed of a left and right pair. Although the lower half split member 3 shown in the present embodiment is not provided with an oil hole, the lower half split member 3 may be provided with an oil hole.

The hardened sections 35 are portions each of which is formed in a range d from each of the end faces 3c and 3d of the lower half split member 3, and are hardened as compared with other portions. The hardened sections 35 are portions (laser modified sections K described later) formed when a steel plate (a blank material B described later) to be a material of the lower half split member 3 is cut by laser cutting using the laser machine and the vicinity of the cut surface is changed in properties by thermal influence of the laser. The range d of each of the hardened sections 35 is 350 μm or less.

Now, a method of cutting the blank material is described.

As shown in FIG. 5, the blank material B, which is a base of the upper half split member 2 and the lower half split member 3, is formed by fixing a plate-shaped bimetal P, scanning an irradiation head H of the laser machine in a predetermined direction and at the same time irradiating a predetermined position on a surface of the bimetal P with a laser L, and being cut into a slit shape. At this time, the laser modified sections K are formed on the cut surfaces of the blank material B by the laser L in a predetermined range d from the end faces. The laser modified sections K are portions to be the hardened sections 25 and 35, and appear on the end faces 2c and 2d of the upper half split member 2 and the end faces 3c and 3d of the lower half split member 3 as shown in FIGS. 2 and 3.

Then, the blank material B cut out in this manner is pressed into a semicircular shape by pressing with a die and a punch, and further, is formed with chamfered sections and groove sections and the like to form the upper half split member 2 and the lower half split member 3. Accordingly, the sliding bearing 1 as shown in FIG. 1 is manufactured.

Now, the hardened sections 25 of the upper half split member 2 are described in more detail. The description is made for the hardened sections 25 of the upper half split member 2 as an example, however, the same description can be made for the hardened sections 35 of the lower half split member 3 and the description thereof is omitted.

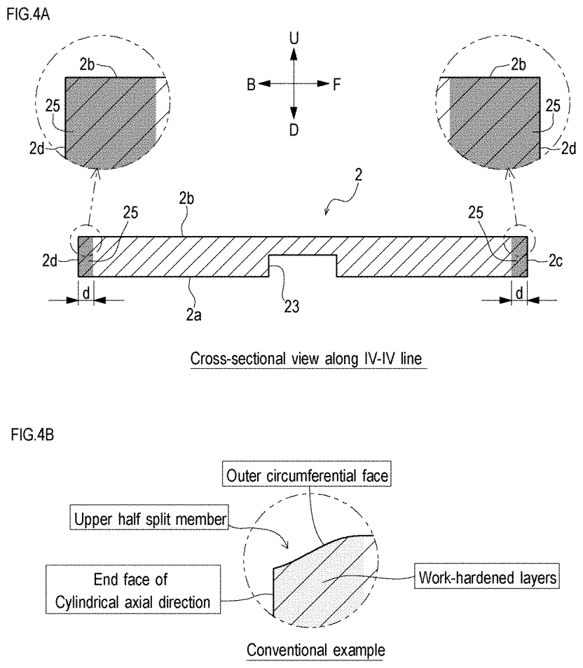

As shown in FIG. 4(A), the upper half split member 2 has the hardened sections 25 on the respective end faces 2c and 2d. The hardened sections 25 are portions formed by laser processing, and are portions quench hardened by the thermal influence of the laser.

For example, in the conventional upper half split member shown in FIG. 4(B), press cutting is performed with a die and a punch when a blank material is cut out, and work-hardened layers are formed on circumferential end faces due to a plastic flow of material. Such work-hardened layers each extend from the end face to a range of about 700 to 1000 μm. The work-hardened layers are factors that reduce the contact area of the sliding bearing with respect to the holder, and are conventionally all removed. In the conventional sliding bearing, the work-hardened layers are removed by cutting front and back ends in the range of 700 to 1000 μm from the end faces.

On the other hand, in the upper half split member 2 shown in FIG. 4(A), laser cutting is performed when the blank material is cut out, and accordingly, the work-hardened layer due to the plastic flow of material is not formed on the end faces of the half split member. Each of the hardened sections 25 formed by laser cutting has the range d from the end face of about 200 to 400 μm, which is smaller than that of the conventional work-hardened layer.

Also, unlike the conventional upper half split member shown in FIG. 4(B), the upper half split member 2 shown in FIG. 4(A) has no inflection point in the shape along the line parallel to the cylinder axis of the outer circumferential face 2b. In the sliding bearing having the above shape, because the reduction in the contact area of the sliding bearing 1 with respect to the holder (not shown) is suppressed, it is not necessary to remove the hardened sections 25.

In this regard, the work-hardened layers formed when the blank material is cut out by the conventional press cutting have a high degree of hardening, but the hardened sections 25 formed when the blank material is cut out by laser cutting have a considerably small degree of hardening. Therefore, when the cut blank material is bent into a semicircular shape, the blank material can be accurately bent without causing unnecessary stress. This is considered to be the reason why there is no inflection point in the shape of the outer circumferential face 2b of the sliding bearing along the line parallel to the cylinder axis.

That is, in each of the hardened sections 25 of the sliding bearing 1, the range d from the end face of the upper half split member 2 in the cylinder axial direction is 350 μm or less, and there is no inflection point in the shape along the line parallel to the cylinder axis of the outer circumferential face 2b of the upper half split member 2. In the sliding bearing 1, with this configuration, the contact property with respect to the holder (not shown) is improved.

As described above, although the upper half split member 2 that constitutes the sliding bearing 1 is provided with the hardened sections 25 having the range d from the end faces of about 200 to 400 μm at the front and back ends, cutting is not required for the hardened sections 25. Alternatively, in the upper half split member 2, even if the hardened sections 25 are removed, the amount of the hardened sections 25 removed can be smaller than the amount of the conventional work-hardened layers removed.

Further, in the upper half split member 2 including the hardened sections 25, the number of portions removed by cutting can be reduced as compared with the conventional case. Therefore, the material yield can be improved.

In summary, the sliding bearing 1 includes the pair of upper half split member 2 and lower half split member 3 obtained by bisecting a cylinder in a direction parallel to the axial direction, and the upper half split member 2 includes the hardened sections 25 at the end faces 2c and 2d in the cylinder axial direction, and the lower half split member 3 includes the hardened sections 35 at the end faces 3c and 3d in the cylinder axial direction. With this configuration, it is possible to improve the material yield in the manufacturing of the sliding bearing 1.

Further, because the hardened sections 25 and 35 of the sliding bearing 1 are the laser modified sections K and do not need to be removed by cutting, the material yield can be further improved.

The sliding bearing 1 shown in the present embodiment exemplifies the sliding bearing including half split bearings each of which is molded from the blank material B having the laser modified sections K. However, the same effect can be obtained in a sliding bearing (so-called cylinder bush) including an integral cylindrical member obtained by molding the blank material B in a cylindrical shape, due to the presence of the hardened sections. That is, in the sliding bearing including the integral cylindrical member molded from the blank material B, the hardened sections are formed on the end faces of the cylindrical member in the cylinder axial direction. Accordingly, improvements in the contact on the rear surface of the cylindrical member with respect to the holder and the material yield are achieved.

### REFERENCE SIGNS LIST

1 Sliding bearing
2 Upper half split member
2c, 2d End face
3 Lower half split member
3c, 3d End face
25 Hardened section
35 Hardened section
K Laser modified section

1. A sliding bearing comprising a pair of half split members formed by bisecting a cylinder in a direction parallel to an axial direction, wherein the half split members have hardened sections on end faces in a cylinder axial direction of the half split members.

2.-4 (canceled)

5. The sliding bearing according to claim 1, wherein each of the hardened sections is a laser modified section.

6. The sliding bearing according to claim 1, wherein the sliding bearing has no inflection point in a shape along a line parallel to a cylinder axis of an outer circumferential face of the sliding bearing.

7. The sliding bearing according to claim 5, wherein the sliding bearing has no inflection point in a shape along a line parallel to a cylinder axis of an outer circumferential face of the sliding bearing.

8. A sliding bearing comprising a cylindrical member formed integrally,
wherein the cylindrical member has hardened sections on end faces in a cylinder axial direction of the cylindrical member.

9. The sliding bearing according to claim , wherein each of the hardened sections is a laser modified section.

10. The sliding bearing according to claim 68, wherein the sliding bearing has no inflection point in a shape along a line parallel to a cylinder axis of an outer circumferential face of the sliding bearing.

11. The sliding bearing according to claim wherein the sliding bearing has no inflection point in a shape along a line parallel to a cylinder axis of an outer circumferential face of the sliding bearing.
